(19) United States
(12) Patent Application Publication
(10) Pub. No.: US 2010/0007258 A1
(43) Pub. Date: Jan. 14, 2010

(54) IMAGE DISPLAY APPARATUS

(75) Inventors: Yukihiro IWATA, Osaka (JP); Shinya OGASAWARA, Hyogo (JP); Takayuki FURUKAWA, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Osaka (JP)

(21) Appl. No.: 12/469,235

(22) Filed: May 20, 2009

(30) Foreign Application Priority Data
Jul. 14, 2008 (JP) 2008-182229

(51) Int. Cl. H01K 1/58

(52) U.S. Cl. 313/12; 313/46

(57) ABSTRACT

An image display device includes a display panel for displaying images, such as a PDP. The display panel includes either a plurality of grooves constituting a plurality of flow paths aligned in a certain direction on its rear surface, or a plurality of flow paths aligned in a certain direction internally. The above-described image display device can enlarge heat radiation area in the display panel, and efficiently decrease the temperature of the display panel.

### BACKGROUND OF THE INVENTION

1. Field of the Invention

The present invention relates to an image display device for displaying television pictures or the like, more specifically, to a heat-radiating structure for a display panel thereof.

2. Related Background Art

In conventional image display devices, structures have been developed for reducing the temperature of a display panel by flowing air, by means of air cooling fans, between a plasma display panel used as the display panel and a chassis (see e.g. JP2000-040474A).

However, in conventional image display devices, there has been a problem that heat conduction from the display panel to air is not sufficient, thereby resulting in undesirably high temperatures for the display panel.

### SUMMARY OF THE INVENTION

The purpose of the present invention is to provide an image display device capable of increasing heat radiation from a display panel and efficiently reducing the temperature of the display panel.

The purpose of the invention can be achieved by the below described image display device. To solve the problem, the image display device includes a display panel for displaying images having, on its rear surface, a plurality of grooves that constitute a plurality of flow paths aligned in a certain direction. Alternatively, the image display device may include a plurality of flow paths that are aligned in a certain direction inside the display panel, and that include cooling fluid.

According to the image display device of the present invention, it is possible to increase the radiation of heat in the display panel, so that the temperature of the display panel is reduced efficiently.

### BRIEF DESCRIPTION OF THE DRAWINGS

FIG. 1 is a vertical cross sectional view at the horizontal center illustrating an image display device according to a first embodiment;

FIG. 2 is a horizontal cross sectional view at the vertical center illustrating the image display device according to the first embodiment;

FIG. 3 is a rear view of a display panel (PDP: Plasma Display Panel) according to the first embodiment;

FIG. 4 is a vertical cross sectional view at the horizontal center illustrating an image display device according to a second embodiment;

FIG. 5 is a horizontal cross sectional view at the vertical center illustrating the image display device according to the second embodiment;

FIG. 6 is a rear view of a display panel (PDP) according to the second embodiment;

FIG. 7 is a vertical cross sectional view at the horizontal center illustrating an image display device according to a third embodiment;

FIG. 8 is a horizontal cross sectional view at the vertical center illustrating the image display device according to the third embodiment;

FIG. 9 is a rear view of a display panel (PDP) according to the third embodiment;

FIG. 10 is a vertical cross sectional view at the horizontal center illustrating an image display device according to a fourth embodiment;

FIG. 11 is a horizontal cross sectional view at the vertical center illustrating the image display device according to the fourth embodiment;

FIG. 12 is a rear view of a display panel (PDP) according to the fourth embodiment;

FIG. 13 is a vertical cross sectional view at the horizontal center illustrating an image display device according to a fifth embodiment;

FIG. 14 is a horizontal cross sectional view at the vertical center illustrating the image display device according to the fifth embodiment; and

FIG. 15 is a rear view of a display panel (PDP) according to the fifth embodiment.

### DETAILED DESCRIPTION OF THE INVENTION

Hereinafter, an image display device according to embodiments of the present invention is described below with reference to the drawings. The components that have the identical function among the embodiments may be indicated with the same numerals, and the descriptions thereof may be omitted.

### First Embodiment

(1-1) Configuration

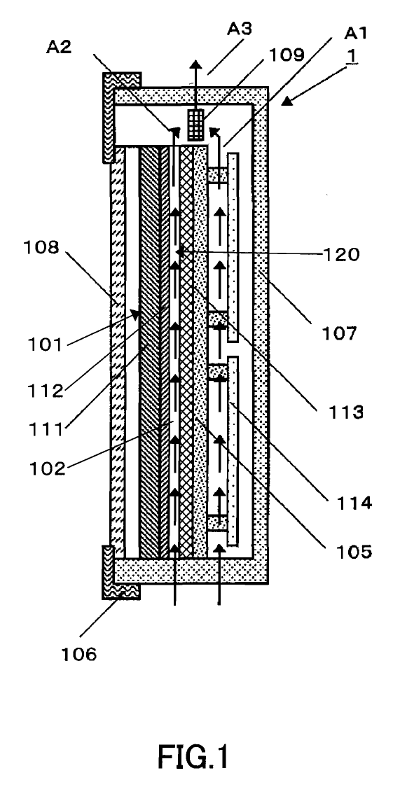

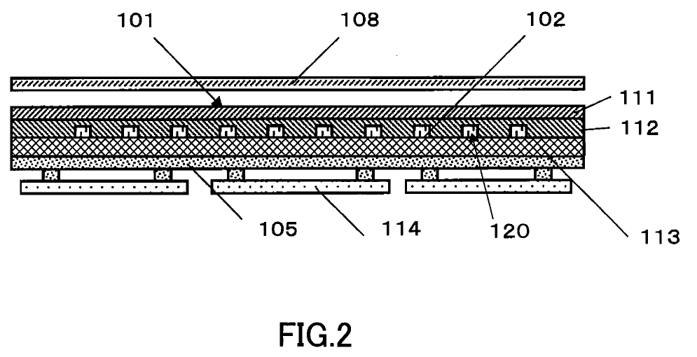

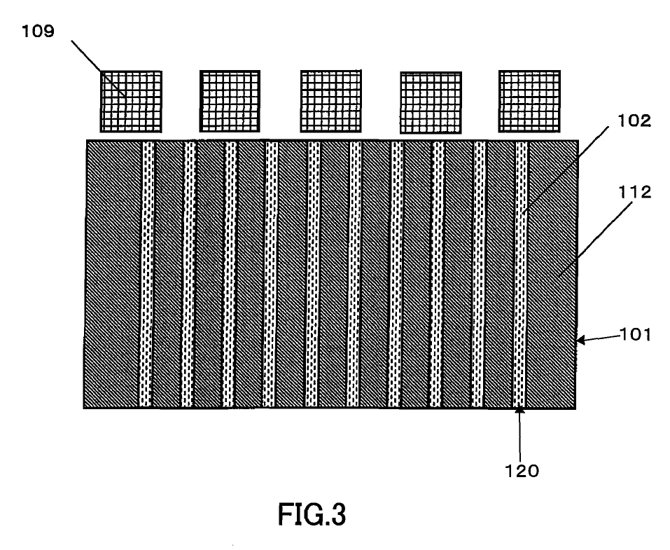

With reference to FIGS. 1 to 3, an image display device 1 in accordance with a first embodiment is described. FIG. 1 is a vertical cross sectional view at the horizontal center illustrating the image display device. FIG. 2 is a horizontal cross sectional view at the vertical center illustrating the image display device, omitting a front cover and a back cover. FIG. 3 is a rear view of the image display device in a state in which a heat conductive sheet, a chassis, circuit boards, and the back cover are omitted.

Here, the horizontal direction means the horizontal direction of the image display device in a normal installation. Normally, the longer side direction of the image display area in the image display device is in parallel with the horizontal direction. Further, the vertical direction means the perpendicular direction of the image display device relative to the horizontal direction in the normal installation. Normally, the shorter side direction of the image display area in the image display device is in parallel with the perpendicular direction. Furthermore, the horizontal direction is also referred to as the lateral direction, and the vertical direction is also referred to as the longitudinal direction. Moreover, in the image display device, the direction in which images are displayed is referred to as the forward direction, and the other direction is referred to as the backward direction. In addition, the surface of each component facing the forward direction is referred to as the front surface, and the surface thereof facing the backward direction is referred to as the rear surface.

The image display device 1 includes a plasma display panel (hereinafter also referred to as a PDP) 101, a chassis 105, a front cover 106, a back cover 107, a front filter 108, air cooling fans 109, a heat conductive sheet 113, and circuit boards 114. The PDP 101 is an example of the display panel.

The PDP 101 has a front glass substrate 111 and a rear glass substrate 112. On the front glass substrate 111, a plurality of display electrode pairs are formed in parallel with a first direction. The display electrode pairs consist of scanning electrodes and sustaining electrodes. On the rear glass substrate 112, a plurality of address electrodes are formed in parallel with a second direction crossing the first direction. The display electrode pairs are covered with a dielectric layer. The dielectric layer is covered with a protective layer made of MgO or the like. Further, red, blue and green phosphors are applied to the rear glass substrate 112. The front glass substrate 111 and the rear glass substrate 112 are bonded to each other. The major surfaces of the front glass substrate 111 and the rear glass substrate 112 are rectangular in shape. The first direction is the longer side direction of the rectangular shape. In general, the PDP 101 is installed in such a manner that its longer side is in the horizontal direction. The second direction is the shorter side direction of the rectangular shape. In general, the PDP 101 is installed in such a manner that its shorter side is in the vertical direction. The front glass substrate 111 and the rear glass substrate 112 each are approximately 1.5 mm to 3 mm in thickness.

A portion defined between the display electrode pair and the address electrode at a position where the display electrode pair intersects with the address electrode, in front-view, is called a discharge cell. The discharge cells are coated with any one of red, blue or green phosphors. Discharge gas including a rare gas such as helium (He), neon (Ne) and xenon (Xe) is enclosed in the discharge cells. Upon applying a voltage to the display electrode pairs and the address electrodes, an electric discharge takes place in the discharge cell, thereby causing generation of ultraviolet rays. Then, phosphors are excited by the generated ultraviolet rays so as to emit lights, and thereby images are displayed.

More specifically, first, a voltage is applied to all the scanning electrodes so that an electric discharge takes place in each discharge cell, which is called an initial discharge. Next, while a voltage is applied to the scanning electrodes in order, a voltage also is applied to the address electrodes crossing over the discharge cells to be illuminated on the voltage-applied scanning electrodes. This is called an address discharge. Thereby, light is emitted in the discharge cells at the intersection between the voltage-applied scanning electrodes and the voltage-applied address electrodes so that the corresponding discharge cells are selected as luminescent cells. Subsequently, sustain discharge, in which an AC (alternating-current) voltage is applied between the scanning electrodes and the sustaining electrodes, is performed. Due to the sustain discharge, only the afore-selected luminescent cells are illuminated, so that the PDP 101 displays images.

When the PDP 101 displays images by generation of electrical discharge inside the discharge cells, the temperature of the PDP 101 itself tends to be high. The high temperature of the PDP 101 can cause changes in discharge characteristics, and thereby erroneous discharges, such as illuminating an unselected pixel or failing to illuminate a selected pixel, tend to occur. As a result, the image display quality may be deteriorated. Further, the high temperature of the PDP 101 may cause a breakage in the front glass substrate 111 and the rear glass substrate 112. Therefore, it is important to release the heat generated in the PDP 101 efficiently and to keep the temperature of the PDP 101 low, e.g. 70° C. to 80° C.

The PDP 101 includes, on its rear surface, a plurality of grooves 102 constituting a plurality of flow paths 120 aligned in the horizontal direction. Here, “aligned in the horizontal direction” means that the alignment direction of the flow paths 120 is approximately in parallel with the horizontal direction. More specifically, the grooves 102 are formed with a predetermined spacing on a surface, facing the chassis 105, of the rear glass substrate 112 constituting the PDP 101. Each groove 102 extends in the vertical direction. Here, “extends in the vertical direction” means that each groove 102 is approximately in parallel with the vertical direction. The grooves 102 are formed on the rear glass substrate 112 from its lower edge to its upper edge, and have openings on the lower and upper edge surfaces of the rear glass substrate 112. In addition, the grooves 102 are closed by the heat conductive sheet 113 from the backward direction, and thereby the flow paths 120, which open toward both ends in the vertical direction, are formed.

The grooves 102 each have an inner surface, which means the bottom and both side surfaces, roughened by sandblasting, for example. More specifically, the surface roughness of the inner surface of each groove 102, measured with the arithmetic average roughness Ra: JIS B0601, is around 2 μm to 20 μm. The inner surface of the groove 102 to be roughened may be the bottom surface of the groove 102 only.

The chassis 105 holds the PDP 101 on one of its surfaces.

The chassis 105 is made of a metal plate, such as aluminum, copper or the like with high heat and electrical conductivity. The major surface of the chassis 105 is approximately the same size as those of the front glass substrate 111 and the rear glass substrate 112, and typically is 1.5 mm to 4 mm in thickness. Further, for reinforcement, a bending process is performed, or a reinforcing rib is provided, as needed. On one surface (the front surface) of the chassis 105, the PDP 101 is mounted via the heat conductive sheet 113. On the other surface (the rear surface) of the chassis 105, the circuit boards 114 are mounted in parallel with the chassis 105.

The chassis 105 serves as a heat-radiating member for absorbing the heat generated in the PDP 101, the circuit boards 114 or the like, so as to release the heat into the air or other members. Further, the chassis 105 serves as a reinforcement member for supporting the PDP 101 and the circuit boards 114, so as to ensure the rigidity. Furthermore, the chassis 105 serves as an electrical ground of the PDP 101, the circuit boards 114, or the like.

The front cover 106 is made of resin, for example. The front cover 106 is a rectangular frame body, open in the center in front-view. The front cover 106 is constituted to cover the peripheral edges of the front filter 108 from the forward direction.

The back cover 107 may be formed by press molding a metal plate. The back cover 107 is fixed to the chassis 105 so as to cover the rear surface of the PDP 101 over the chassis 105 and the circuit boards 114. The back cover 107 includes vent holes, not shown in figures, on the lower surface and the upper surface of the vertical direction, thereby allowing the air to be replaced between outside and inside the back cover 107. The back cover 107 has electrical conductivity, and shields electromagnetic waves emitted from the PDP 101, the circuit boards 114, or the like.

The front filter 108 is arranged in front of the PDP 101. The front filter 108 has a transparent substrate made of glass or resin such as acrylic, in a rectangular shape, and various functional films formed on the transparent substrate. Specific examples of the functional films include an antireflection film, a coloring film, a neon-cut film, a near infrared absorption film, and a conductive film.

The air cooling fans 109 are fixed to the back cover 107. The air cooling fans 109 forcibly discharge the air from the inside of the back cover 107 into the outside through the vent holes of the upper surface, and increase the efficiency of the air flow into the inside of the back cover 107 through the vent holes of the lower surface. Here, the air cooling fans 109 may flow the air forcibly from the outside into the inside of the back cover 107, and increase the efficiency of discharging the air from the inside to the outside of the back cover 107.

Axial fans, centrifugal fans and the like may be used as the air cooling fans 109. In this embodiment, the centrifugal fans are used as the air cooling fans 109. The centrifugal fans used in this embodiment suction the air from the front and the rear of the fans, and discharge the air upwardly. A plurality of the air cooling fans 109 (five fans are depicted in the illustrated example) are arranged in the lateral direction at a position vertically above the chassis 105. Further, the air cooling fans 109 are disposed forward of the rear surface of the chassis 105 and backward of the front surface of the conductive sheet 113. In other words, the air cooling fans 109 are located backward of the flow paths 120.

Air flows into the inside of the back cover 107through the vent holes provided on the lower surface in the vertical direction of the back cover 107. Then, the air flows between the chassis 105 and the circuit boards 114 (as indicated by arrows A1). The air also flows between the PDP 101 and the chassis 105 (as indicated by arrows A2). More specifically, the air flows inside the flow paths 120 (as indicated by arrows A2). Finally, the air is suctioned from the front and the rear of the air cooling fans 109, and discharged from the top of the air cooling fans 109 through the vent holes provided on the upper surface in the vertical direction of the back cover 107 (as indicated by an arrow A3).

The conductive sheet 113 is provided between the rear surface of the PDP and the front surface of the chassis 105. The conductive sheet 113 covers over almost the entire rear surface of the PDP 101. The conductive sheet 113 is generally made of material such as silicon rubber with relatively high heat conductivity and flexibility. Both surfaces of the conductive sheet 113 may be adhesive, thereby allowing the conductive sheet 113 and the chassis 105 to be bonded to each other, and the conductive sheet 113 and the PDP 101 to be bonded to each other. Thus, the chassis 105 can hold the PDP 101.

The circuit boards 114 include a sustain board, a scan board, and a data control board for controlling image display; a tuner board for receiving pictures; a digital signal processing board for processing pictures; a power circuit board for supplying power to each section; and the like. The sustain board applies a voltage to the sustaining electrodes. The scan board applies a voltage to the scanning electrodes. The data control board applies a voltage to the address electrodes.

(1-2) Operation

Subsequently, the operation of the image display device 1 is described hereinafter.

The PDP 101 is a self emission device, and the PDP 101 itself generates heat. In other words, the PDP 101 is an exothermic body. The heat generated by electrical discharges in the PDP 101 is conducted to the rear glass substrate 112 in the PDP 101.

If the rear glass substrate 112 does not include grooves 102, the larger part of the rear glass substrate 112 does not contact with the air. In that case, most of the heat of the rear glass substrate 112 is conducted to the heat conductive sheet 113, and conducted from the heat conductive sheet 113 to the chassis 105. The heat is radiated from the chassis 105 into the air.

On the other hand, according to this embodiment, the rear glass substrate 112 includes the grooves 102 that constitute the flow paths 120 opening upwardly and downwardly. The inner surface of each groove 102 is in contact with the air. Therefore, it is possible to radiate heat directly into the air from the inner surface of each groove 102. Accordingly, compared with the case where the rear glass substrate 112 does not include grooves 102, the radiation efficiency of the PDP 101 is high.

Further, due to providing the grooves 102, the contact area between the rear glass substrate 112 and the air is increased, so that the radiation efficiency is far higher. Furthermore, since the inner surface of each groove 102 is roughened, the contact area between the rear glass substrate 112 and the air is increased, so that the radiation efficiency is far higher.

The grooves 102 are formed approximately in parallel with the vertical direction, so that the air inside the flow paths 120 flows efficiently due to natural convection. As a result, the radiation efficiency is improved further. In addition, the air forcibly flows inside the flow paths 120 by the air cooling fans 109 (as indicated by the arrows A2), so that the radiation efficiency is far higher.

In the bottom surface, namely in the most forwardly positioned surface, of each groove 102, the heat is absorbed at a nearer position to the electrical discharge section being heat source, thereby allowing an efficient heat conduction into the air.

Here, part of the heat from the PDP 101 is conducted from the rear glass substrate 112 to the heat conductive sheet 113, and conducted from the heat conductive sheet 113 to the chassis 105. Then, the heat is radiated from the chassis 105 to the air.

The heat generated in the circuit boards 114 is conducted to the air (as indicated by the arrows A1) flowing from below the circuit boards 114. The air (as indicated by the arrows A1) that has absorbed the heat from the circuit boards 114 and the chassis 105 converges at the air cooling fans 109 with the air (as indicated by arrows A2) that has absorbed the heat from the inner surfaces of the grooves 102. The confluent air is discharged from the vent holes (heat radiation holes) provided in the upper surface of the back cover 107 to the outside of the image display device (as indicated by arrows A3).

In the above described configuration, by separating the main radiation channel of the PDP 101 from the main radiation channel of the circuit boards 114, the heat interference between the two is reduced, and thereby an efficient heat radiation of the PDP 101 and the circuit boards 114 is enabled.

### Second Embodiment

(2-1) Configuration

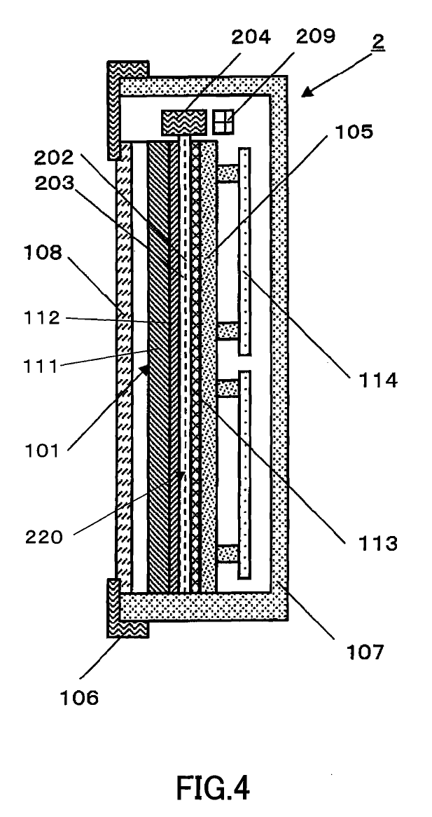

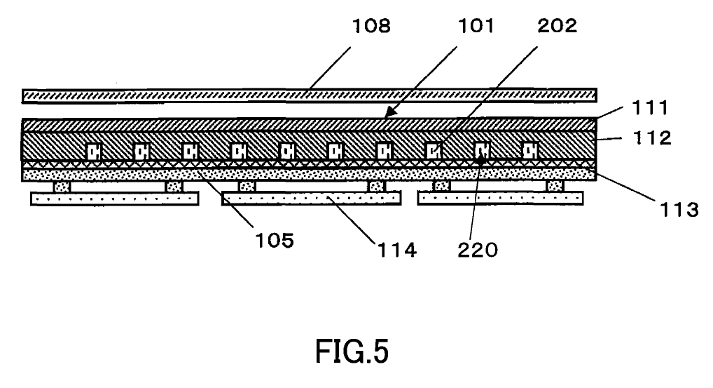

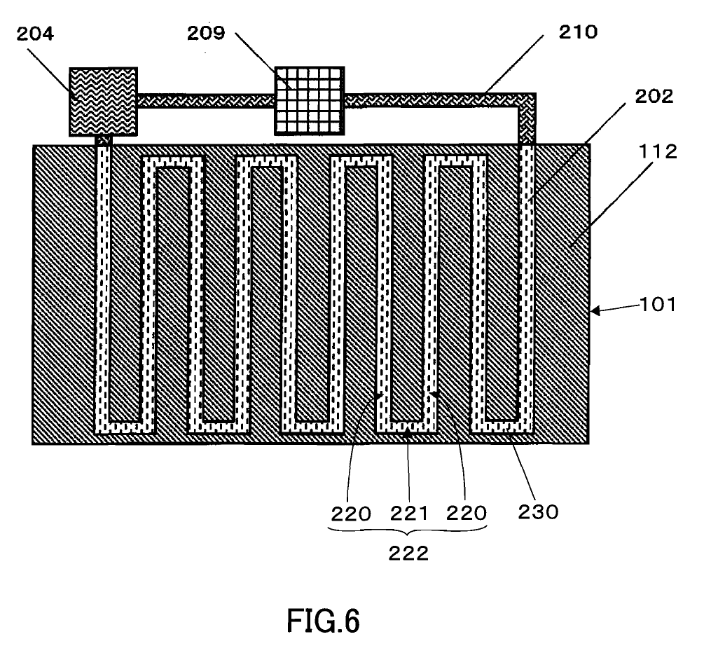

With reference to FIGS. 4 to 6, an image display device 2 in accordance with a second embodiment is described. FIG. 4 is a vertical cross sectional view at the horizontal center illustrating the image display device. FIG. 5 is a horizontal cross sectional view at the vertical center illustrating the image display device, omitting a front cover and a back cover. FIG. 6 is a rear view of the image display device in a state in which a heat conductive sheet, a chassis, circuit boards, and the back cover are omitted.

The image display device 2 includes a PDP 101, cooling fluid 203, a pump 204, a chassis 105, a front cover 106, a back cover 107, a front filter 108, air cooling fans 209, a conveying tube 210, a heat conductive sheet 113, and circuit boards 114.

The PDP 101 includes, on its rear surface, not only a plurality of grooves 202 constituting a plurality of flow paths 220 aligned in the horizontal direction, but also a plurality of second grooves 230 that constitute a plurality of connection paths 221. The connection paths 221 connect the flow paths 220 that are adjacent to each other and continuously connect all the flow paths 220 so as to form a continuous path 222. More specifically, the grooves 202 each extend in the vertical direction, and are formed with a predetermined spacing on a surface, facing the chassis 105, of the rear glass substrate 112 that constitutes the PDP 101. The second grooves 230 are formed on a surface of the rear glass substrate 112 facing the chassis 105, so as to couple two adjacent upper ends and couple two adjacent lower ends of the grooves 202, alternately therebetween. Accordingly, the continuous path 222 has a serpentine shape extending in the lateral directions.

The upper ends of the most outward grooves 202 among the grooves 202 reach the upper edge of the rear glass substrate 112, while the lower ends thereof, and both ends of the other grooves 202, do not reach either the lower edge or the upper edge of the rear glass substrate 112, respectively. The grooves 202 and the second grooves 230 are closed by the heat conductive sheet 113 from the backward direction, and thereby the continuous path 222 that has openings only on both ends is formed. Here, there may be a case where the upper ends of the most outward grooves 202 do not reach the upper edge of the rear glass substrate 112, and a through hole is provided at a corresponding position in the chassis 105 to each of the upper ends of the most outward grooves 202, thereby allowing both ends of the continuous path to open.

The grooves 202 and the second grooves 230 each have an inner surface, which means the bottom and both side surfaces, roughened by sandblasting, for example. More specifically, the surface roughness of the inner surface of each groove 202, measured with the arithmetic average roughness Ra, is around 2 μm to 20 μm.

The conductive sheet 113 is provided between the PDP 101 and the chassis 105. Due to the compression bonding of the conductive sheet 113 onto the surface of the rear glass substrate 112 on which the grooves 202 and the second grooves 230 are formed, a string of the continuous path 222 is formed of the grooves 202 and the second grooves 230, and the conductive sheet 113. Here, airtightness can be maintained except for both ends of the continuous path 222. The continuous path 222 is filled with the cooling fluid 203.

The cooling fluid 203 may be a mixed liquid of antifreezing agent, such as ethylene glycol, with water, for example.

The conveying tube 210 is filled with the cooling fluid 203 therein. Both ends of the conveying tube 210 are respectively connected to the upper ends of the most outward grooves 202, namely both ends of the continuous path 222. In other word, the conveying tube 210 forms a circulation path as a closed loop in combination with the continuous path 222. The circulation path is filled with the cooling fluid 203. Further, in the middle of the conveying tube 210, the pump 204 for circulating the cooling fluid 203 along the circulation path is provided.

The air cooling fans 209 are fixed to the back cover 107. In this embodiment, the air cooling fans 209 are arranged behind the conveying tube 210 lapping over the conveying tube 210. The air cooling fans 209 forcibly draw air from the outside of the back cover 107 and blow the air to the conveying tube 210. The air blown to the conveying tube 210 is discharged to the outside of the back cover 107 through the vent holes of the back cover 107. Axial fans, centrifugal fans and the like may be used as the air cooling fans 209. In this embodiment, axial fans are used as the air cooling fans 209.

(2-2) Operation

Subsequently, the operation of the image display device 2 is described hereinafter.

The heat generated by electrical discharges in the PDP 101 is conducted to the rear glass substrate 112 in the PDP 101. Then, the heat is conducted from the rear glass substrate 112 to the cooling fluid 203 filling the inside of the continuous path 222 that is constituted of the grooves 202 and the second grooves 230, and the heat conductive sheet 113. The cooling fluid 203 runs through the continuous path 222, in the rear surface of the PDP 101, absorbing the heat from the PDP 101. The cooling fluid 203 that has absorbed the heat in the rear surface of the PDP 101 is conveyed to the conveying tube 210 provided outside the PDP 101 by the pump 204. Due to exposing the conveying tube 210 to wind, namely air, by the air cooling fans 209, the air absorbs the heat of the cooling fluid 203 from the surface of the conveying tube 210. As a result, the cooling fluid 203 is cooled. The cooled cooling fluid 203 is returned to the continuous path 222 in the rear surface of the PDP 101 by the pump 204. Thus, by circulating the cooling fluid 203, the efficient heat radiation of the PDP 101 is enabled.

Further, since the inner surfaces of the grooves 202 and the second grooves 230 each are roughened, the contact area between the rear glass substrate 112 and the cooling fluid 203 is further increased, so that the radiation efficiency is far higher.

In addition, the continuous path 222 on the rear surface of the PDP 101 is constituted of the grooves 202 and the second grooves 230, and the conductive sheet 113, so that the continuous path 222 can be formed easily.

### Third Embodiment

(3-1) Configuration

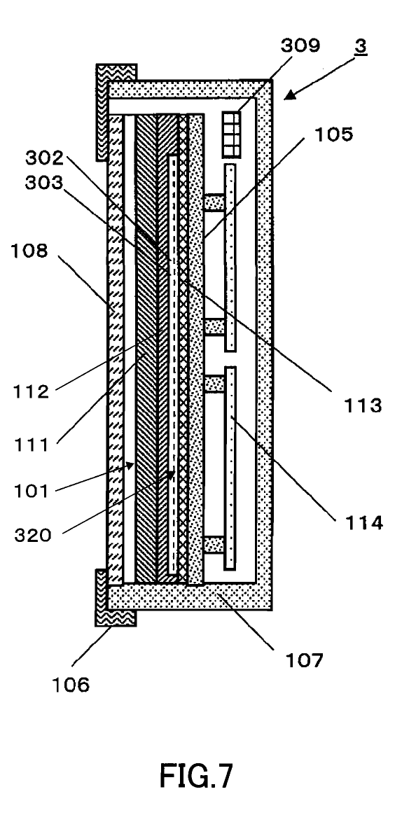

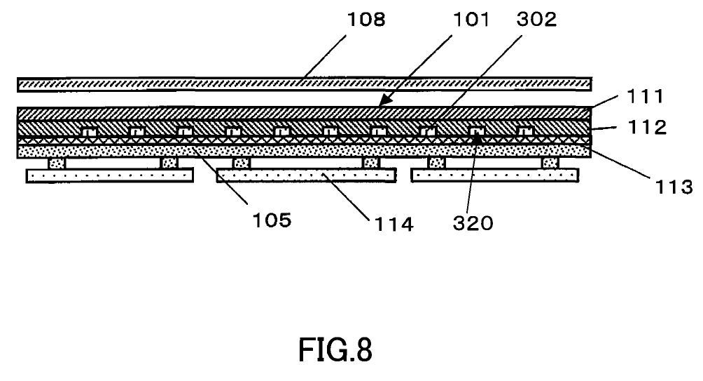

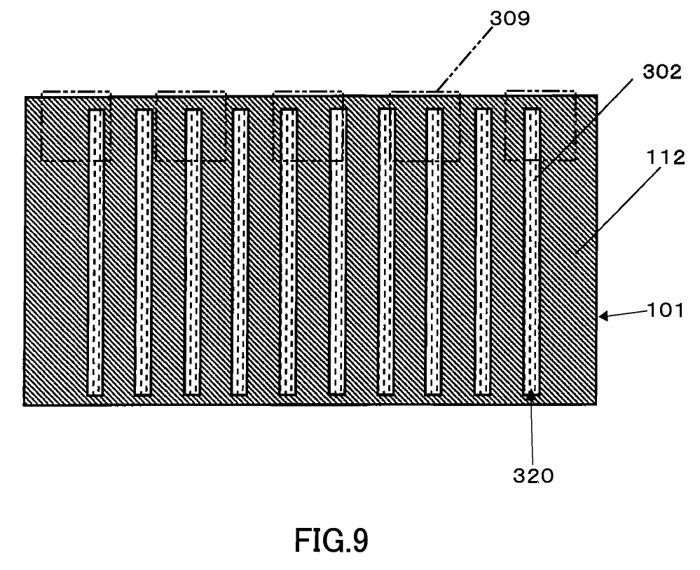

With reference to FIGS. 7 to 9, an image display device 3 in accordance with a third embodiment is described. FIG. 7 is a vertical cross sectional view at the horizontal center illustrating the image display device. FIG. 8 is a horizontal cross sectional view at the vertical center illustrating the image display device, omitting a front cover and a back cover. FIG. 9 is a rear view of the image display device in a state in which a heat conductive sheet, an aluminum chassis, circuit boards, and the back cover are omitted.

The image display device 3 includes a PDP 101, cooling fluid 303, a chassis 105, a front cover 106, a back cover 107, a front filter 108, air cooling fans 309, a heat conductive sheet 113, and circuit boards 114.

The PDP 101 includes, on its rear surface, a plurality of grooves 302 constituting a plurality of flow paths 320 aligned in the horizontal direction. More specifically, the grooves 302 are formed with a predetermined spacing on a surface, facing the chassis 105, of the rear glass substrate 112 that constitutes the PDP 101. Each groove 302 extends in the vertical direction. The upper ends of the grooves 302 do not reach the upper edge of the rear glass substrate 112, and the lower ends of the grooves 302 do not reach the lower edge of the rear glass substrate 112, respectively. In addition, the grooves 302 are closed by the heat conductive sheet 113 from the backward direction, and thereby the flow paths 320 each being a closed space are formed.

The grooves 302 each have an inner surface, which means the bottom and both side surfaces, roughened by sandblasting, for example. More specifically, the surface roughness of the inner surface of each groove 302, measured with the arithmetic average roughness Ra, is around 2 μm to 20 μm.

The conductive sheet 113 is provided between the PDP 101 and the chassis 105. Due to the compression bonding of the conductive sheet 113 onto the surface of the rear glass substrate 112 on which the grooves 302 are formed, a plurality of bar-shaped closed spaces are formed. The airtightness is maintained in each bar-shaped closed space. In the flow paths 320, each being a bar-shaped closed space, the cooling fluid 303 is enclosed with air at a reduced pressure. Accordingly, the pressure inside each flow path 320 is lower than the atmospheric pressure.

Pure water may be used as the cooling fluid 303. Fluorocarbons such as hydrochlorofluorocarbon (HCFC) and hydrofluorocarbon (HFC), and hydrocarbons such as methanol and acetone may be used other than pure water.

The air cooling fans 309 are fixed to the back cover 107. A plurality of the air cooling fans 309 (five fans are depicted in the figure) are arranged behind the chassis 105, along the upper edge of the chassis 105, in lateral direction. The air cooling fans 309 forcibly draw air from the outside of the back cover 107 and blow the air to the upper section of the chassis 105. The air blown to the chassis 105 is discharged to the outside of the back cover 107 through the vent holes of the back cover 107. Axial fans, centrifugal fans and the like may be used as the air cooling fans 309. In this embodiment, axial fans are used as the air cooling fans 309.

(3-2) Operation

Subsequently, the operation of the image display device 3 is described hereinafter.

The heat generated by electrical discharges in the PDP 101 is conducted to the rear glass substrate 112 in the PDP 101. Then, the heat causes evaporation of the cooling fluid 303 enclosed in the flow paths 320, each being a closed space and constituted of the groove 302 and the heat conductive sheet 113. The cooling fluid 303 absorbs the heat from the PDP 101, as latent heat accompanied by the phase change from liquid to gas, so as to reduce the temperature of the PDP 101. The evaporated cooling liquid 303 rises inside each flow path 320 so as to reach the upper edge of the PDP 101. The air cooling fans 309 are arranged at a position corresponding to the upper edge of the PDP 101 so that the evaporated and risen cooling fluid 303 of high temperature is cooled. More specifically, the heat is conducted from the evaporated and risen cooling fluid 303 through the heat conductive sheet 113 to the chassis 105, so as to be radiated from the chassis 105 into the air. As a result, the temperature of the cooling fluid 303 is decreased, and the phase changes from gas to liquid. The liquefied cooling fluid 303 falls along the inner peripheral surface of each flow path 320 by gravity. Part of the cooling fluid 303 falling along the inner peripheral surface reaches the lower section of each flow path 320. Another part of the cooling fluid 303 falling along the inner peripheral surface absorbs the heat from the PDP 101 before reaching the lower section of each flow path 320, so as to evaporate and rise again.

Further, since the inner surface of each groove 302 is roughened, the contact area between the rear glass substrate 112 and the cooling fluid 303 is increased, so that the radiation efficiency is far higher. Furthermore, such surface roughening enables the conveyance of the cooling fluid 303 using not only gravity but also capillary action. As a result, it becomes possible further to increase the conveyable amount of heat. Similar effects also can be obtained by providing furrows on the inner surface of each groove 302, extending in the vertical direction along the flow paths 320. In addition, similar effects can also be obtained by arranging plaited wires along the inner peripheral surface of each flow path 320 so that capillary action can be used.

In this case, each closed space on the rear surface of the PDP 101 is constituted of the groove 302 and the conductive sheet 113, so as to be formed easily.

### Fourth Embodiment

(4-1) Configuration

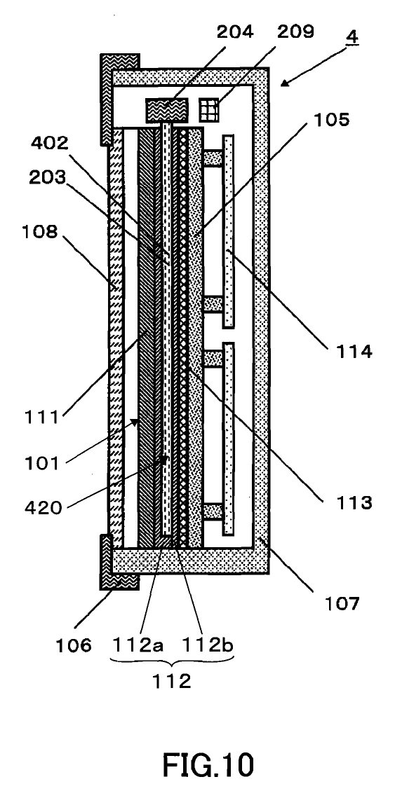

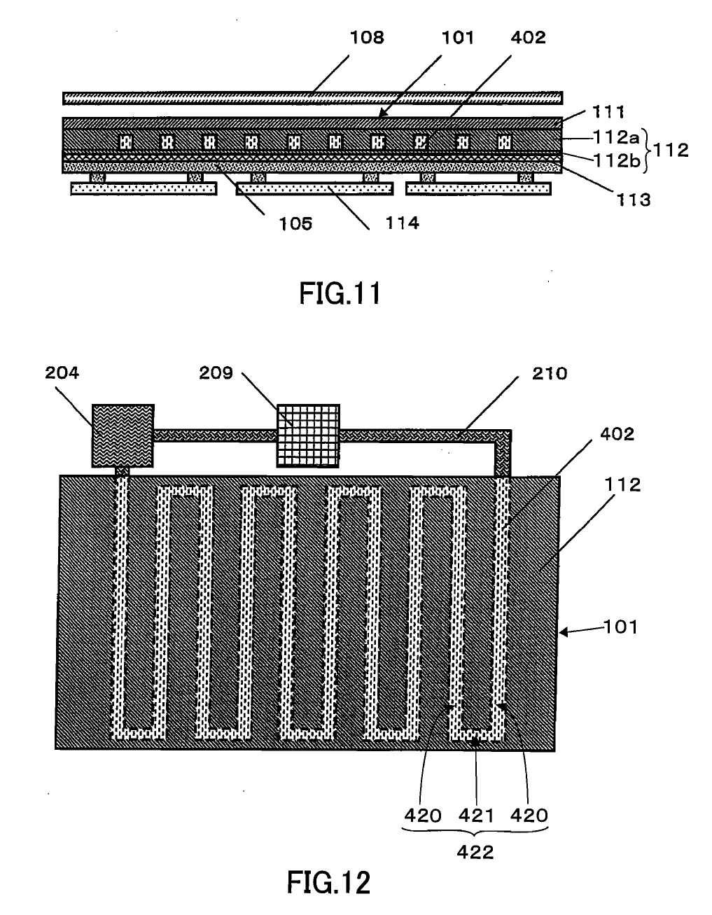

With reference to FIGS. 10 to 12, an image display device 4 in accordance with a fourth embodiment is described. FIG. 10 is a vertical cross sectional view at the horizontal center illustrating the image display device. FIG. 11 is a horizontal cross sectional view at the vertical center illustrating the image display device, omitting a front cover and a back cover. FIG. 12 is a rear view of the image display device in a state in which a heat conductive sheet, an aluminum chassis, circuit boards, and the back cover are omitted.

The image display device 4 includes a PDP 101, a pump 204, a chassis 105, a front cover 106, a back cover 107, a front filter 108, air cooling fans 209, a conveying tube 210, a heat conductive sheet 113, and circuit boards 114. Further, the image display device 4 includes cooling fluid 203 in flow paths 420 that will be described below.

The PDP 101 internally includes a plurality of the flow paths 420 aligned in the horizontal direction. Further, the PDP 101 internally includes a plurality of connection paths 421 for connecting the flow paths 420 that are adjacent to each other and continuously connecting all the flow paths 420 so as to form a continuous path 422. Each flow path 420 extends in the vertical direction, and the connection paths 421 connect two adjacent upper ends and connect two adjacent lower ends of the flow path 420, alternately therebetween. More specifically, the continuous path 222 is constituted of the grooves 202 and the second grooves 230, and the conductive sheet 113 in the second embodiment, however, the continuous path 422 is internally formed in-plane of the rear glass substrate 112 that constitutes the PDP 101 in this embodiment. In order to manufacture such a rear glass substrate 112, the rear glass substrate 112 may be constituted of a first substrate 112a and a second substrate 112b bonded to each other, and the continuous path 402 having a serpentine shape extending in the lateral directions may be formed in either the first substrate 112a or the second substrate 112b, in a similar manner to the second embodiment. In the illustrated examples, the continuous path 402 is formed on the first substrate 112a of the front side.

The flow paths 420 and the connection paths 421 each have an inner peripheral surface roughened by sandblasting, for example. More specifically, the surface roughness of the inner peripheral surface of each of the flow path 420 and connection path 421, measured with the arithmetic average roughness Ra, is around 2 μm to 20 μm. Although it is not necessary that the entire part of the inner peripheral surface of each flow path 420 and connection path 421 is roughened, it is preferable that the forefront surface be roughened at least.

Other configurations are substantially the same as those of the second embodiment. In other words, both ends of the conveying tube 210 are connected respectively to both ends of the continuous path 422. The circulation path formed of the continuous path 422 and the conveying tube 210 is filled with the cooling fluid 203. The pump 204 circulates the cooling fluid 203 along the circulation path.

(4-2) Operation

Subsequently, the operation of the image display device 4 is described hereinafter.

The heat generated by electrical discharges in the PDP 101 is conducted to the rear glass substrate 112 in the PDP 101. Then, the heat is conducted from the rear glass substrate 112 to the cooling fluid 203 filling the inside of the continuous path 422. The cooling fluid 203 runs through the continuous path 422, inside the PDP 101, absorbing the heat from the PDP 101. The cooling fluid 203 that has absorbed the heat inside the PDP 101 is conveyed to the conveying tube 210 provided outside the PDP 101 by the pump 204. Due to exposing the conveying tube 210 to wind, namely air, by the air cooling fans 209, the air absorbs the heat of the cooling fluid 203 from the surface of the conveying tube 210. As a result, the cooling fluid is cooled. The cooled cooling fluid 203 is returned to the continuous path 422 inside the PDP 101 by the pump 204. Thus, by circulating the cooling fluid 203, the efficient heat radiation of the PDP 101 is enabled.

Further, since the inner peripheral surfaces of the flow paths 420 and the connection paths 421 each are roughened, the contact area between the rear glass substrate 112 and the cooling fluid 203 is increased, so that the radiation efficiency is far higher.

### Fifth Embodiment

(5-1) Configuration

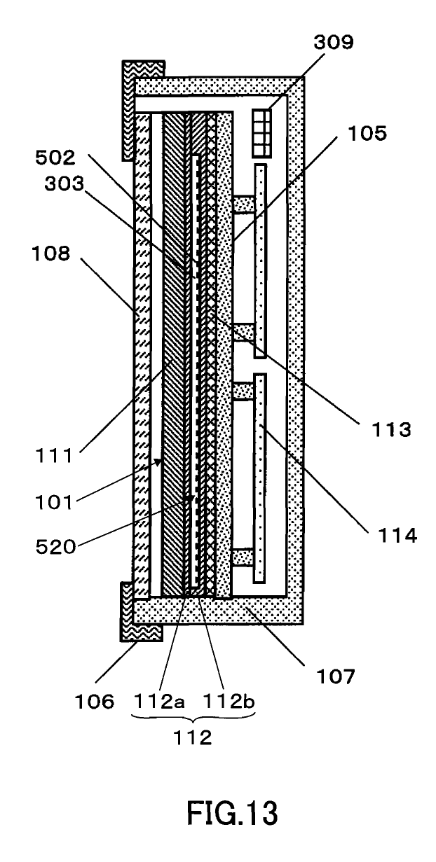

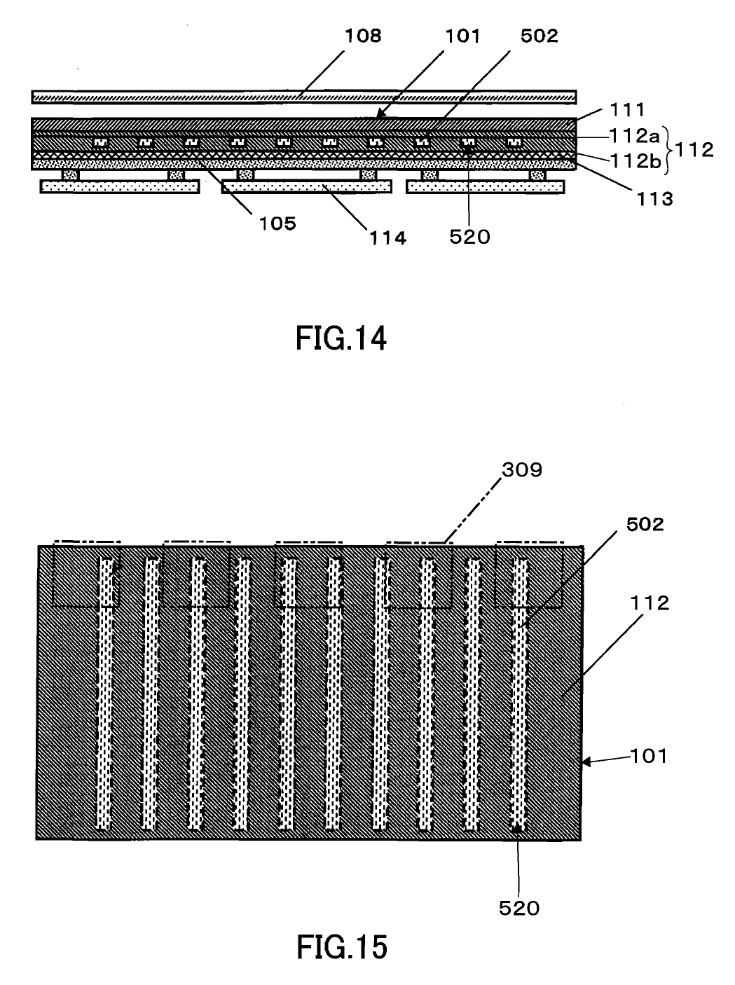

With reference to FIGS. 13 to 15, an image display device 5 in accordance with a fifth embodiment is described. FIG. 13 is a vertical cross sectional view at the horizontal center illustrating the image display device. FIG. 14 is a horizontal cross sectional view at the vertical center illustrating the image display device, omitting a front cover and a back cover. FIG. 15 is a rear view of the image display device in a state in which a heat conductive sheet, an aluminum chassis, circuit boards, and the back cover are omitted.

The image display device 5 includes a PDP 101, a chassis 105, a front cover 106, a back cover 107, a front filter 108, air cooling fans 309, a heat conductive sheet 113, and circuit boards 114. Further, the image display device 5 includes cooling fluid 203 in flow paths 520 that will be described below.

The PDP 101 internally includes a plurality of the flow paths 520 aligned in the horizontal direction. More specifically, the flow paths 520 are formed with a predetermined spacing inside the rear glass substrate 112 that constitutes the PDP 101. Each flow path 520 extends in the vertical direction. The upper ends of the flow paths 520 do not reach the upper edge of the rear glass substrate 112, and the lower ends of the flow paths 520 do not reach the lower edge of the rear glass substrate 112, respectively. In other words, each flow path 520 is a closed space. In order to manufacture such the rear glass substrate 112, the rear glass substrate 112 may be constituted of a first substrate 112a and a second substrate 112b bonded to each other, and grooves 502 extending in the vertical direction may be formed in either the first substrate 112a or the second substrate 112b, in a similar manner to the third embodiment. In the illustrated examples, the grooves 502 are formed on the second substrate 112b of the rear side.

The flow paths 520 each have an inner peripheral surface roughened by sandblasting, for example. More specifically, the surface roughness of the inner peripheral surface of each flow path 520, measured with the arithmetic average roughness Ra, is around 2 μm to 20 μm.

Each flow path 520 is a bar-shaped closed space. The airtightness is maintained in the bar-shaped closed space. In each flow path 520 being a bar-shaped closed space, the cooling fluid 303 is enclosed with air at a reduced pressure. Accordingly, the pressure inside the closed space is lower than the atmospheric pressure.

In the third embodiment, each groove 302 and the conductive sheet 113 form a closed space, however, in this embodiment, each flow path 520 is internally formed in-plane of the rear glass substrate 112 that constitutes the PDP 101, and each flow path 520 itself is a closed space.

(5-2) Operation

Subsequently, the operation of the image display device 5 is described hereinafter.

The heat generated by electrical discharges in the PDP 101 is conducted to the rear glass substrate 112 in the PDP 101. Then, the heat causes evaporation of the cooling fluid 303 enclosed in the flow paths 520. The cooling fluid 303 absorbs the heat from the PDP 101, as latent heat accompanied by the phase change from liquid to gas, so as to reduce the temperature of the PDP 101. The evaporated cooling liquid 303 rises inside each flow path 520 so as to reach the upper edge of the PDP 101. The air cooling fans 309 are arranged at a position corresponding to the upper edge of the PDP 101 so that the evaporated and risen cooling fluid 303 of high temperature is cooled. More specifically, the heat is conducted from the evaporated and risen cooling fluid 303 through the heat conductive sheet 113 to the chassis 105, so as to be radiated from the chassis 105 into the air. As a result, the temperature of the cooling fluid 303 is decreased, and the phase changes from gas to liquid. The liquefied cooling fluid 303 falls along the inner peripheral surface of each flow path 520 by gravity. Part of the cooling fluid 303 falling along the inner peripheral surface reaches the lower section of each flow path 520. Another part of the cooling fluid 303 falling along the inner peripheral surface absorbs the heat from the PDP 101 before reaching the lower section of each flow path 520, so as to evaporate and rise again.

Furthermore, since the inner peripheral surface of each flow path 520 is roughened, the contact area between the rear glass substrate 112 and the cooling fluid 303 is further increased, so that the radiation efficiency is far higher. Furthermore, such surface roughening enables the conveyance of the cooling fluid 303 using not only gravity but also capillary action. As a result, it becomes possible to further increase the conveyable amount of heat. Similar effects can also be obtained by providing furrows on the inner peripheral surface of each flow path 520, extending in the vertical direction along the closed space. In addition, similar effects can also be obtained by arranging plaited wires along the inner peripheral surface of each flow path 520 so that capillary action can be used.

### Other Embodiments

In the above described embodiments, although the heat conductive sheet 113 is provided between the PDP 101 and the chassis 105, the conductive sheet may be omitted. In the second embodiment, the continuous path 222 may be formed of the grooves 202 and the second grooves 230, and another member, the chassis 105, for example. In the first embodiment and the third embodiment, the flow paths 120/320 may be formed of the grooves 102/302 and another member, the chassis 105, for example.

In the second embodiment and the fourth embodiment, although the flow paths 220/420 are provided approximately in the vertical direction, the flow paths 220/420 may be provided in the horizontal direction.

In the third embodiment and the fifth embodiment, although the flow paths 320/520 are provided in the vertical direction so that the heat of the PDP 101 moves to the upper section of the PDP 101 so as to be radiated by means of air cooling fans, the flow paths 320/520 may be provided in the horizontal direction so that the heat in the central section of the PDP 101 moves to the laterally peripheral sections so as to be radiated by means of air cooling fans.

In the above described embodiments, although a structure in which the air inside the back cover is discharged using fans has been described, the present invention is not limited to such a structure. A structure in which an image display device is internally cooled by using only natural convection through vent holes, without using fans may be employed.

In the above described embodiments, although a plasma display panel used as a display panel has been described as an example, the present invention also can be applied to a liquid crystal display, an EL (Electroluminescence) display, or the like.

In addition, concrete numerical values or the like used in the above described embodiments are no more than an example. Therefore, it is possible that such a value may be set optimally based on the characteristics of display panels, the specifications of display devices, or the like.

### Feature of the Embodiments

An image display device according to the above-described embodiments includes a display panel for displaying images, and a plurality of grooves constituting a plurality of flow paths aligned in a certain direction are provided on the rear surface of the display panel. Thus, the temperature of the display panel can be reduced efficiently.

Further, in an image display device according to the above-described embodiments, each groove extends in the vertical direction, and the flow paths are aligned in the horizontal direction. Thus, by using rise of the gas or liquid by buoyancy and fall of the liquefied cooling liquid inside the flow paths by gravity, the circulation can be accelerated. As a result, the temperature of the display panel can be reduced efficiently.

An image display device according to the above described embodiments further includes cooling fluid in the flow paths. Thus, it becomes possible that the amount of heat absorption from the display panel is increased so that the temperature of the display panel can be reduced efficiently.

In an image display device according to the above described embodiments, the display panel includes, on its rear surface, second grooves each constituting a connection path for connecting the flow paths that are adjacent to each other and continuously connecting all the flow paths so as to form a continuous path. The image display device further includes a conveying tube forming a circulation path in combination with the continuous path. The circulation path is filled with the cooling fluid. A pump for circulating the cooling fluid along the circulation path is provided in the conveying tube. Thus, the temperature of the display panel can be reduced efficiently.

In an image display device according to the above described embodiments, each flow path is a closed space, and cooling fluid is enclosed in the flow path with air at a reduced pressure. Thus, the heat generated in the display panel can be conveyed to the upper edge of the display panel, so that the temperature of the display panel can be reduced efficiently.

Alternatively, an image display device according to the above described embodiments includes a display panel for displaying images, a plurality of flow paths aligned in a certain direction inside the display panel, the flow paths including cooling fluid. Thus, the temperature of the display panel can be reduced efficiently.

An image display device according to the above described embodiments further includes connection paths for connecting the flow paths that are adjacent to each other and continuously connecting all the flow paths so as to form a continuous path, and a conveying tube forming a circulation path in combination with the continuous path. In the image display device, the circulation path is filled with the cooling fluid, and the conveying tube includes a pump for circulating the cooling fluid along the circulation path. Thus, the heat generated in the display panel can be conveyed to the outside from the rear surface of the display panel, so that the temperature of the display panel can be reduced efficiently.

In an image display device according to the above described embodiments, each flow path is a closed space, and the cooling fluid is enclosed in each flow path with air at a reduced pressure. Thus, the heat generated in the display panel can be conveyed to the upper edge of the display panel, so that the temperature of the display panel can be reduced efficiently.

Further, in an image display device according to the above-described embodiments, each flow path extends in the vertical direction, and the flow paths are aligned in the horizontal direction. Thus, by using rise of the gas or liquid by buoyancy and fall of the liquefied cooling liquid inside the flow paths by gravity, the circulation can be accelerated. As a result, the temperature of the display panel can be reduced efficiently.

The above described embodiments are no more than an example of the present invention. The present invention is not limited to the above described embodiments. It is needless to mention that various changes that are obvious to those skilled in the art are intended to be included within the scope of the present invention.

As described above, the image display device of the present invention is capable of efficiently reducing the temperature of the display panel, so as to be useful as a flat image display device with large screen.

What is claimed is:

1. An image display device comprising:
a display panel for displaying images,
wherein the display panel includes, on its rear surface, a plurality of grooves constituting a plurality of flow paths aligned in a certain direction.

2. The image display device according to claim 1,
wherein each of the grooves extends in the vertical direction, and
the flow paths are aligned in the horizontal direction.

3. The image display device according to claim 1,
wherein the flow paths include cooling fluid therein.

4. The image display device according to claim 3,
wherein the display panel includes, on its rear surface, second grooves each constituting a connection path for connecting the flow paths that are adjacent to each other and continuously connecting all the flow paths so as to form a continuous path;
the image display device further comprises a conveying tube forming a circulation path in combination with the continuous path;
the circulation path is filled with the cooling fluid; and
a pump for circulating the cooling fluid along the circulation path is provided in the conveying tube.

5. The image display device according to claim 3,
wherein each of the flow paths is a closed space, and
the cooling fluid is enclosed in each of the flow paths with air at a reduced pressure.

6. The image display device according to claim 1,
wherein the grooves each have a roughened inner surface.

7. The image display device according to claim 1,
wherein the display panel is a plasma display panel.

8. An image display device comprising:
a display panel for displaying images; and
a plurality of flow paths aligned in a certain direction inside the display panel, the flow paths including cooling fluid.

9. The image display device according to claim 8, further comprising:
connection paths for connecting the flow paths that are adjacent to each other and continuously connecting all the flow paths so as to form a continuous path; and
a conveying tube forming a circulation path in combination with the continuous path,
wherein the circulation path is filled with the cooling fluid; and
a pump for circulating the cooling fluid along the circulation path is provided in the conveying tube.

10. The image display device according to claim 8,
wherein each of the flow paths is a closed space, and
the cooling fluid is enclosed in each of the flow paths with air at a reduced pressure.

11. The image display device according to claim 8,
wherein each of the flow paths extends in the vertical direction, and
the flow paths are aligned in the horizontal direction.

12. The image display device according to claim 8,
wherein the flow paths each have a roughened inner peripheral surface.

13. The image display device according to claim 8,
wherein the display panel is a plasma display panel.
